(19) United States
(12) Patent Application Publication
(10) Pub. No.: US 2002/0062669 A1
(43) Pub. Date: May 30, 2002

(54) Handcuff removal tool

(76) Inventor: Darin W. Lance, Benson, AZ (US)

Correspondence Address: Durando, Birdwell & Janke PLC, 2929 E. Broadway Blvd., Tucson, AZ, 85716, US

(21) Appl. No.: 09/726,931

(22) Filed: Nov. 30, 2000

(51) Int. Cl. E05B 75/00

(52) U.S. Cl. 70/16

(57) ABSTRACT

A handcuff and leg cuff removal tool has two grabbing mechanisms attached to the ends of a pair of levers. The grabbing mechanisms comprise pairs of cams which engage the ratchet arm and body of a hand/leg cuff. The levers are class one levers and have a common pivot pin. Force is applied via the levers to move the grabbing mechanisms away from each other. The cams grip the handcuff as force is applied. Force is applied via the levers sufficient to cause the ratchet arm to pull away from the locking mechanism in the body of the restraint. A leverage ratio of 10:1 provides sufficient leverage to permit a person to manually operate the tool.

### BACKGROUND OF THE INVENTION

1. Field of the Invention

This invention is related in general to the field of restraining devices and, in particular, to tools for removing, opening, or defeating handcuffs, leg cuffs, and similar devices.

2. Description of the Related Art

The use of restraint devices such as handcuffs and leg cuffs are widely used by law enforcement to control prisoners. Such devices are used by local, state, federal, and military law enforcement and also by prison and correctional officers. Handcuffs are the best known restraint. A typical handcuff 10 is illustrated in FIG. 1. The ratchet arm 11 is rotatably attached to the cheek plates 12. Ratchet arm 11 rotates into the body 13 and engages the locking mechanism or pawl 14. The teeth of the ratchet arm 11 engage with the teeth of the pawl 14 thereby securing ratchet arm 11 in a closed and locked position. A key unlocks the handcuff via keyway 15.

A problem occurs when the key is lost, misplaced, destroyed, or otherwise unavailable and the restraining device must be opened or removed from a person. In this situation, the most common removal technique uses bolt cutters to cut the restraint. Another technique uses various saws to cut the restraint. The disadvantages of either technique are readily apparent.

Bolt cutters are capable of cutting the restraints, however, they may inadvertently cause injury to the person wearing the restraint. Restraints are often applied very tightly. This leaves little room for error between the restraint and the skin of the person wearing the restraint. Consequently, bolt cutters often injure, scratch, or cut the person wearing the restraint. In addition to injuries and pain, there is also concern for infectious disease, particularly when the skin is broken and bleeding is involved.

Saws, both manual and powered, are also capable of cutting a restraint. However, saws may be even more likely to cause injury.

Clearly there exists the need for an improved restraint removal tool which solves the problems associated with removing a restraint when the key is unavailable, reduces injury and/or infection risk to the wearer, and is quick and simple to use.

### BRIEF SUMMARY OF THE INVENTION

The invention discloses a tool for removing a handcuff, leg cuff, or similar restraint from a person or object. The tool has two grabbing mechanisms attached to the ends of a pair of levers. The grabbing mechanisms engage the ratchet arm and body of the restraint. The levers are class one levers having a common pivot pin. Force is applied via the levers to extract the ratchet arm from the restraint body and overcome the locking mechanism of the restraint.

The two grabbing mechanisms use cams to grip the restraint. The grabbing cams are well suited to this application since cams increase their grip as force is increased. Several embodiments are envisioned. In one embodiment pairs of cams grip both sides of the restraint. In an alternate embodiment, the restraint is gripped between a cam and a stationary pressure plate.

The grabbing mechanisms are positioned around the restraint such that the cams grab the sides of the restraint. One grabbing mechanism is positioned to grab a ratchet arm. The other grabbing mechanism is positioned to grab the body of the restraint. The removal tool is operated to apply sufficient separating force between the ratchet arm and the body so that the locking mechanism of the restraint is overcome and the ratchet arm is separated from the body.

The force is applied via levers. The grabbing mechanisms are mounted on the ends of two levers. The levers share a common pivot pin. The levers are configured such that force applied via the levers is leveraged to move the grabbing mechanisms away from each other. The longer the handles of the levers are, the less force need be applied to the handles to overcome the locking mechanism. A 10:1 ratio between the length of the handles to the length from the pivot pin to the grabbing mechanisms provides sufficient mechanical advantage for manual operation.

As sufficient force is applied to separate the ratchet arm from the body, the teeth of the ratchet arm plasticate and slide backwards over the harder teeth of the pawl.

The invention reduces the risk of injury to a person wearing the restraint. Sharp cutting surfaces and saw blades are not needed. There is reduced risk of pain, cuts, infection, and anxiety to the wearer.

Therefore, an object of the invention is to remove a restraint from a person or object

A feature of the invention is two grabbing mechanisms mounted on two levers.

Another feature of the invention is a grabbing mechanism comprising a cam.

Advantages of the invention include easy removal of restraints, saved time, reduced chance of injury, reduced risk of infection, and reduced emotional distress.

Various other purposes and advantages of the invention will become clear from its description in the specification that follows and from the novel features particularly pointed out in the appended claims. Therefore, to the accomplishment of the objectives described above, this invention consists of the features hereinafter illustrated in the drawings, fully described in the detailed description of the preferred embodiment and particularly pointed out in the claims.

However, such drawings and description disclose only some of the various ways in which the invention may be practiced.

### BRIEF DESCRIPTION OF THE DRAWINGS

FIG. 1 illustrates a typical handcuff.

FIG. 2 is a top view illustrating the cams.

FIG. 3 is side view of two cams in FIG. 2.

FIG. 4 is a top view of the lever heads with the cams removed.

FIG. 5 is a side view of the lever heads and handleds.

FIG. 6 is the hinge.

FIG. 7 is a side view of the hinge.

FIG. 8 is illustrates an embodiment using pressure plates.

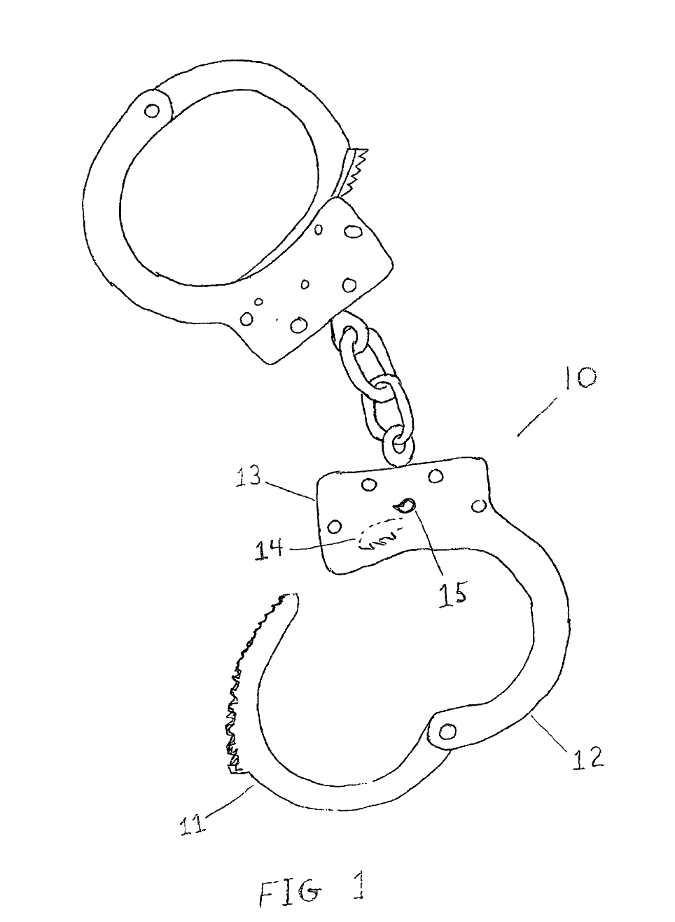

### DESCRIPTION OF THE PREFERRED EMBODIMENT OF THE INVENTION

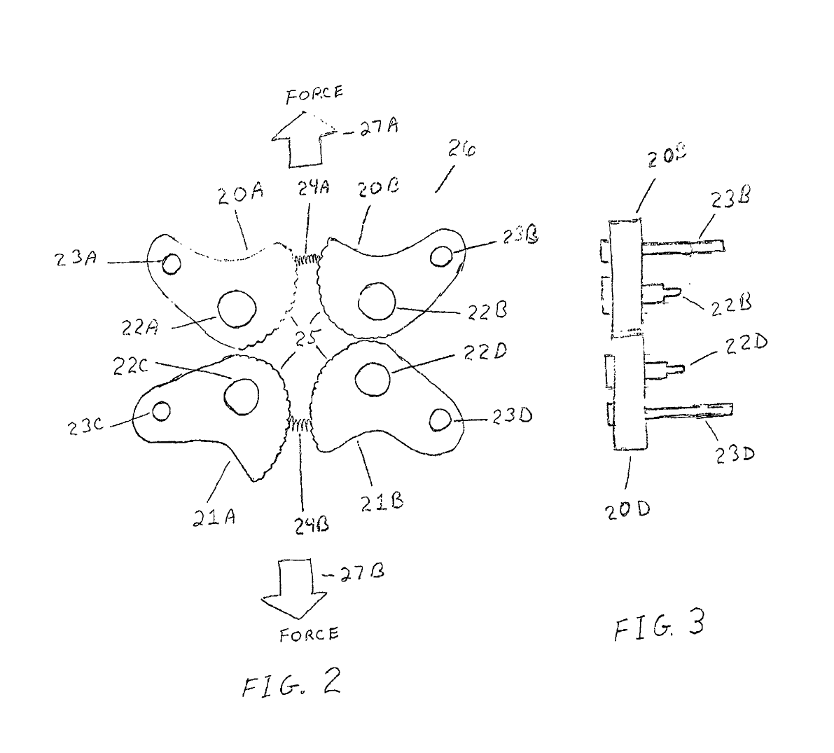

FIG. 2 is a top view of the removal tool 26 illustrating the grabbing mechanism of the invention. Only the cams and related bolts and springs are shown. The underlying levers, hinge, and bolts are not shown. Shown in FIG. 2 are ratchet arm cams 20A and 20B, handcuff body cams 21A and 21B (also referred to restraint body cams), securing bolts 22A-22D, movement restricting bolts 23A-23D, and springs 24A-24B.

Cams 20-21 rotate about bolts 22 subject to interference by restricting bolts 23A-23D and springs 24. Springs 24 attach between restricting bolts 23. Springs 24 apply force to urge cams 20-21 to contact the sides of a restraint when it is inserted between one of the pairs of cams 20 or 21. Teeth 25 aid cams 20-21 in grabbing a restraint.

In operation, cams 20-21 are positioned to engage a locked restraint 10. The removal tool 26 is maneuvered such that a portion of a ratchet arm 11 is between ratchet arm cams 20 and a portion of restraint body 13 is between restraint body cams 21. During this positioning step it is recommended to rotate each cam 20-21 to widen the space between cams 20-21 and facilitate placement of restraint 10 between cams 20-21.

When cams 20-21 are positioned for grabbing the restraint, force 27 is applied via attached levers 50 to move ratchet arm cams 20 away from restraint body cams 21. The ratchet arm 11 and restraint body 13, being securely gripped by cams 20-21, are pulled in opposite directions with sufficient force to overcome the locking mechanism.

Cams 20-21 are made of hardened steel while the heads and hinges are made from high carbon steel. The securing bolts are hardened. The teeth of ratchet arm 11 have a lower Rockwell hardness then pawl 14 and, therefore, plasticate and slide backwards over pawl 14 when sufficient force is applied.

Securing bolts 22 are preferably ⅜ inch×½ inch socket shoulder bolts. Springs 24 are preferably 7/16 inch×2 inches×0.062 inch in size.

FIG. 3 is a side view of cams 20B and 21B. Also shown are cam securing bolts 22B and 22D and movement restraining bolts 23B and 23D. Securing bolts 22 are of conventional design and allow cams 20-21 to rotate while securing cams 20-21 to the heads of the levers. Movement restraining bolts serve the duel purposes of anchoring springs 24 and preventing cams 20-21 from rotating too far. Motion restricting bolts 23 limit rotating of cams 20-21 when restricting bolts 23 contact the heads 40 of levers 50.

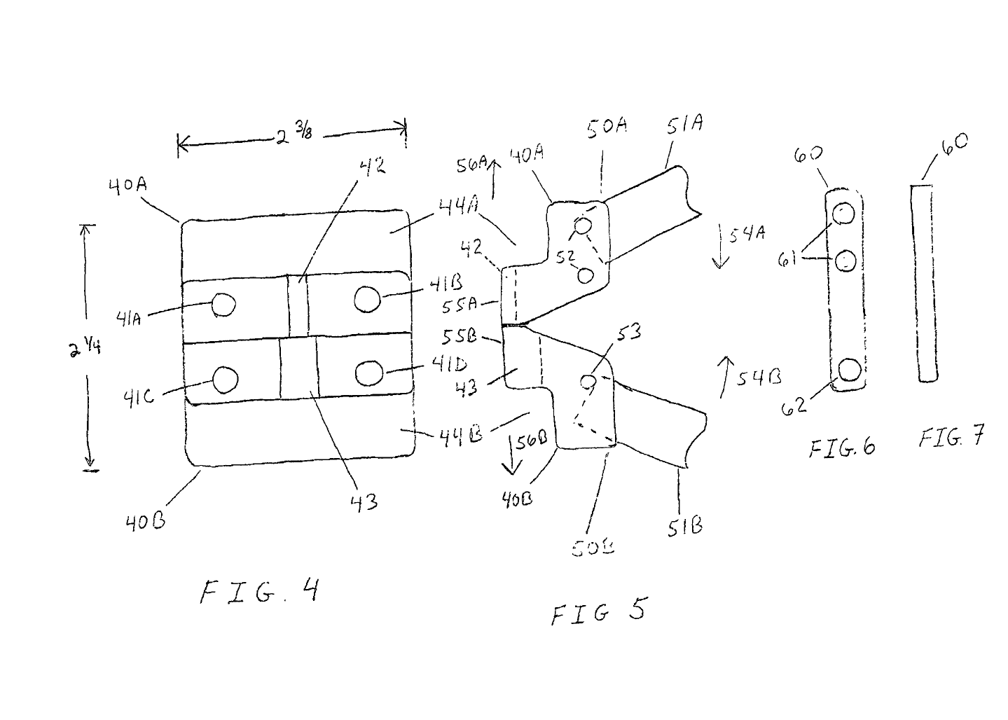

FIG. 4 is a top view of the removal tool with cams 20 and 21 removed. This view shows the top view of heads 40 which are part of levers 50. The dimensions of the pair of heads 40 is 2½ inches×2⅜ inches as illustrated. Threaded securing bolt holes 41 receive securing bolts 22. Ratchet arm channel 42 is cut out of head 40A. In operation, a ratchet arm of a restraint is positioned in said ratchet arm channel 42 so that ratchet arm cams 23A-23B can fully engage and grab the ratchet arm. Ratchet arm channel 42 is preferably 7/32 inch wide. Restraint body channel 43 performs the same function for positioning a body of a restraint. Channel 43 is preferably 13/32 inch wide. Cutouts 44 provide space for springs 24.

FIG. 5 is a side view of the heads 40 of FIG. 4. Heads 40 are mounted on lever handles 51 to form levers 50. Also shown are cutouts 44, ratchet arm channel 42 (dash lines), and restraint body channel 43 (dash lines). Hinge holes 52 receive hinge bolts 61 for securing hinge 60 to lever head 40A. Pivot hole 53 receives pivot bolt 62 for rotatably attaching hinge 60 to head 40B. Pivot hole 53 and pivot bolt 62 are the fulcrum for levers 50. Handles 51 may be made as long as desired. Testing indicates that a 10:1 leverage advantage is adequate for operation. Handle holes, illustrated by dash lines, receive handles into heads 40. Handles 51 are ⅝ inch solid round cold rolled steel.

In operation, as handles 50 are moved together, as shown by arrows 54, the tops 55 of heads 40 move as shown by arrows 56.

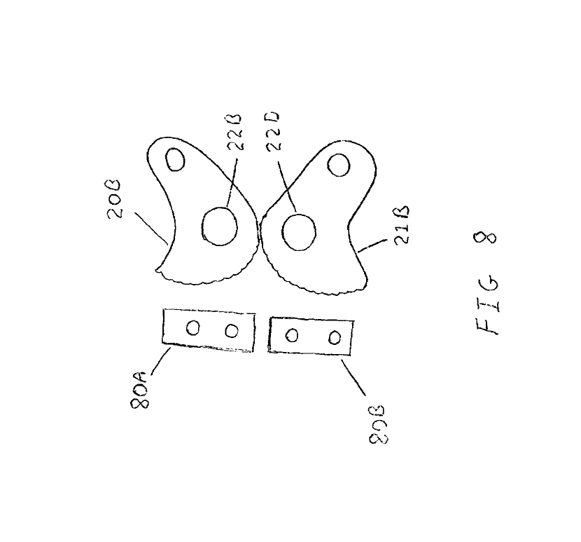

FIG. 6 shows hinge 60, hinge bolts 61, and pivot bolt 62. FIG. 7 is a side view of hinge 60 without bolts. FIG. 8 illustrates an alternate embodiment wherein one the pairs of grabbing cams are replaced with a single cam and a pressure plate. The embodiment illustrated in FIG. 7 is an alternative to the grabbing mechanisms illustrated in FIG. 2. Ratchet arm pressure plate 80A forms a grabbing mechanism with ratchet arm cam 20B. Similarly, restraint body pressure plate 80B forms a grabbing mechanism with restraint body cam 20D.

The method of using the invention follows from the above description. The restraint-removing tool is positioned on a locked restraint such as a handcuff. A ratchet arm of the restraint is grabbed with a first grabbing mechanism such as ratchet arm cams 23A-23B. The body of the restraint is grabbed with a second grabbing mechanism such as restraint body cams 23C and 23D. Separating force is exerted on said ratchet arm and restraint body via said first and second grabbing mechanisms, said force sufficient to overcome the locking mechanism of the restraint.

Those of ordinary skill in the art recognize that several variations of this invention and method are possible. The invention can also be sized to accommodate different size restraints.

Various changes in the details, steps and components that have been described may be made by those skilled in the art within the principles and scope of the invention herein illustrated and defined in the appended claims. For example, various configurations of levers and grabbing cams could be used with equivalent results. Thus, while the present invention has been shown and described herein in what is believed to be the most practical and preferred embodiment, it is recognized that departures can be made therefrom within the scope of the invention, which is not to be limited to the details disclosed herein but is to be accorded the full scope of the claims so as to embrace any and all equivalent processes and products.

I claim:

1. A handcuff removal tool, comprising:
(a) first lever having a first head at one end;
(b) at least one ratchet arm cam rotatably mounted on said first head, said ratchet arm cam for engaging a ratchet arm of said handcuff;
(c) a second lever having a second head at one end;
(d) at least one handcuff body cam rotatably mounted on said second head, said handcuff body cam for engaging a body of said handcuff; and,
(e) wherein said first and second levers are class 1 levers having a common fulcrum.

2. The handcuff removal tool according to claim 1 further comprising a ratchet arm pressure plate mounted on said first head for grabbing said ratchet arm between said pressure plate and said ratchet arm cam.

3. The handcuff removal tool according to claim 1 further comprising a handcuff body pressure plate mounted on said second head for grabbing said handcuff body between said handcuff body pressure plate and said body cam.

4. The handcuff removal tool according to claim 1 wherein said first head includes a ratchet arm channel for receiving a ratchet arm of a handcuff.

5. The handcuff removal tool according to claim 1 wherein said second head includes a handcuff body channel for receiving a body of a handcuff.

6. The handcuff removal tool according to claim 1 further comprising an ratchet arm cam spring attached to said at least one ratchet arm cam for urging said ratchet arm cam to engage the ratchet arm of a handcuff.

7. The handcuff removal tool according to claim 1 further comprising a handcuff body cam spring attached to said at least one handcuff body cam for urging said body cam to engage the body of a handcuff.

8. A method of opening a locked hand/leg cuff, said method comprising:
grabbing a ratchet arm of said cuff with a first grabbing mechanism;
grabbing a body of said cuff with a second grabbing mechanism; and,
exerting separating force on said first and second grabbing mechanisms, said force sufficient to overcome the locking mechanism of said cuff.

9. The method of opening a locked hand/leg cuff according to claim 8 wherein said first grabbing mechanism comprises a pair of cams.

10. The method of opening a locked hand/leg cuff according to claim 8 wherein said second grabbing mechanism comprises pair of cams.

11. The method of opening a locked hand/leg cuff according to claim 8 wherein said first grabbing mechanism comprises a cam and pressure plate.

12. The method of opening a locked hand/leg cuff according to claim 8 wherein said second grabbing mechanism comprises a cam and pressure plate.

13. The method of opening a locked hand/leg cuff according to claim 8 wherein said first grabbing mechanism is attached to a head of a first lever and said second grabbing mechanism is attached to a head of a second lever, said first and second levers manipulated to exert said force.

14. The method of opening a locked hand/leg cuff according to claim 13 wherein said first and second levers are class one levers having a common pivot point.

15. The method of opening a locked hand/leg cuff according to claim 9 further comprising a first spring attached between said pair of cams for urging said pair of cams to grab said ratchet arm.

16. The method of opening a locked hand/leg cuff according to claim 10 further comprising a second spring attached between said pair of cams for urging said pair of cams to grab said body of said cuff.

17. A restraining device removal apparatus, comprising:
(a) a first lever;
(b) a ratchet arm grabbing mechanism attached to a head of said first lever;
(c) a second lever having a common fulcrum with said first lever; and,
(d) a restraint body grabbing mechanism attached to a head of said second lever.

18. The restraining device removal apparatus according to claim 17 wherein said ratchet arm grabbing mechanism comprises a pair of rotatably mounted cams.

19. The restraining device removal apparatus according to claim 17 wherein said ratchet arm grabbing mechanism comprises a rotatably mounted cam and pressure plate

20. The restraining device removal apparatus according to claim 17 wherein said restraint body grabbing mechanism comprises a pair of rotatably mounted cams.

21. The restraining device removal apparatus according to claim 17 wherein said restraint body grabbing mechanism comprises a rotatably mounted cam and pressure plate

22. The restraining device removal apparatus according to claim 18 further comprising an arm grabbing spring attached between said pair of cams for urging said cams to grab said ratchet arm.

23. The restraining device removal apparatus according to claim 19 further comprising an arm grabbing spring attached to said cam for urging said cam to grab said ratchet arm.

24. The restraining device removal apparatus according to claim 20 further comprising a body grabbing spring attached between said pair of cams for urging said cams to grab said restraint body.

25. The restraining device removal apparatus according to claim 21 further comprising a body grabbing spring attached to said cam for urging said cam to grab said restraint body.

26. The restraining device removal apparatus according to claim 17 wherein the head of said first lever includes a channel for receiving the ratchet arm of a restraint.

27. The restraining device removal apparatus according to claim 17 wherein the head of said second lever includes a channel for receiving the body of a restraint.
